(19) United States
(12) Patent Application Publication
(10) Pub. No.: US 2015/0067343 A1
(43) Pub. Date: Mar. 5, 2015

(54) TAMPER RESISTANCE OF AGGREGATED DATA

(71) Applicant: Steven L. Grobman, El Dorado Hills, CA (US)

(72) Inventor: Steven L. Grobman, El Dorado Hills, CA (US)

(21) Appl. No.: 14/125,391

(22) PCT Filed: Aug. 30, 2013
(86) PCT No.: PCT/US13/57584

§ 371 Date: Dec. 11, 2013

(51) Int. Cl. G06F 21/60; G06F 21/64; G06F 21/53; H04L 9/32

(52) U.S. Cl. CPC G06F 21/60; H04L 9/3247; G06F 21/64; G06F 21/53
USPC 713/176; 713/194

(57) ABSTRACT

By processing aggregated data in a trusted environment, a system can reduce opportunities for tampering with aggregated data that is processed in a peer-to-peer chain. Each device may pass the predecessor aggregated data to a trusted environment in that device, which obtains local data for that device and aggregates it with the predecessor aggregated data, producing an output aggregated data. Optionally, the system can identify when a device has previously processed the aggregated data, reducing the possibility that the device can be used to aggregate data repeatedly. The aggregated data may be digitally signed or encrypted to enhance the tamper resistance of the data payload.

### TECHNICAL FIELD

Embodiments described herein generally relate to system management and in particular to a technique for improving tamper resistance of aggregated data in an enterprise management solution.

### BACKGROUND ART

The systems management industry is embracing new capabilities where peer-to-peer networking enables close to real-time analysis of enterprise environments. The capability is scalable because data can be aggregated in a peer-to-peer fashion versus every endpoint establishing a point-to-point connection with a common server. For example if information technology (IT) wishes to understand how many instances exist of every version of an application, a data payload can be passed between a set of peers and when a client evaluates the version that the client has, the client can simply increment a counter and pass the updated payload to the next client.

However, if any client in the chain is compromised, that client can tamper with the results and nullify the value of the data that is collected. Every client agent in the chain has the ability to unseal, update, and re-seal the aggregated data payload.

A way to mitigate the damage that any single client can inflict on the overall result while maintaining the efficiencies that peer-to-peer data aggregation capabilities enable would be advantageous.

### BRIEF DESCRIPTION OF DRAWINGS

FIG. 1 is a block diagram illustrating a prior art peer-to-peer system.

FIG. 2 is a block diagram illustrating a system for improving tamper resistance of aggregated data according to one embodiment.

FIG. 3 is a block diagram illustrating a programmable device on which a technique for improving tamper resistance is implemented according to one embodiment.

FIG. 4 is a flowchart illustrating a technique for improving tamper resistance of aggregated data according to one embodiment.

FIG. 5 is a flowchart illustrating a technique for aggregating data in a trusted environment according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

As used herein, the term “a programmable device” can refer to a single programmable device or a plurality of programmable devices working together to perform the function described as being performed on or by a programmable device. The programmable device can be any type of programmable device, including desktop computers, laptop computers, servers, and mobile devices, including devices containing embedded computational capability.

As used herein, “a trusted environment” is a segregated execution environment on the platform that is able to execute only trusted code. Often, a trusted environment can attest (or prove) that it is an instance of a trusted environment prior to having keys provisioned into the environment. Examples of trusted environments can be implemented on co-processors or secondary cores or as part of the platform architecture, such as with an attested virtual machine manager or trust-zone like capability. An “untrusted environment” is any environment not a trusted environment.

The details of the techniques and apparatus used for communicating between programmable devices are not relevant to the current disclosure, and any desired communication technique may be used, although most commonly the devices communicate using TCP/IP protocols. Although the following description is written in terms of peer-to-peer communications, implementations are not limited to traditional peer-to-peer networking techniques, but may be implemented using any networking or communications technologies for communicating between programmable devices. Although illustrated in the Figures and described herein as a chain of programmable devices, each passing aggregated data on to a single successor programmable device, implementations could use one-to-many, many-to-one, and many-to-many techniques for passing aggregated data from one programmable device to one or more successor programmable devices, with any desired connectivity between programmable devices, using wired or wireless techniques.

Conventional implementations of peer-to-peer data aggregation are completely software-based, and have no way to limit the impact on aggregated data by even a single compromised client in path of the aggregated data. Conventional systems may use digital signature techniques to detect direct corruption of the transmitted data, they cannot detect corruption of the data by a device that has the ability to unseal the signed data, corrupt the underlying data payload, and resign the corrupted data. Although non-aggregated data can be individually signed by the sourcing device, is less efficient than using an aggregated approach and increases the amount of data passed around the network. In addition, conventional techniques fail to detect or prevent use of one device from being used multiple times.

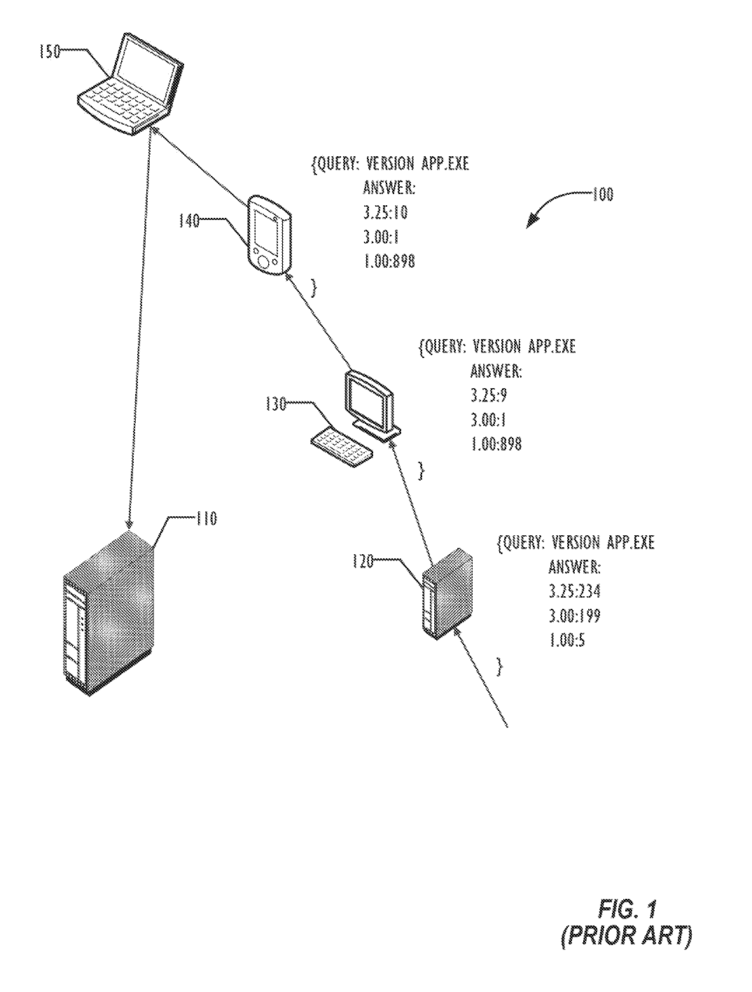

FIG. 1 is a block diagram illustrating an example of a corrupted data aggregation created by one device in the aggregation process according to the prior art. The data being aggregated in this example is a response to a query regarding what version of a particular application (in this example, APP.EXE), are available on the devices in the network 100. In this example, a server 110 collects aggregated data created by clients 120-150, which each of programmable devices 120-150 receiving aggregated responses to the query from their respective predecessor, updating the aggregated data with a local response, then passing the aggregated data on to their respective successor, either another client 130-150 or the server 110. As indicated by FIG. 1, the programmable devices may be different types of programmable devices.

The format of the query and the response data is arbitrarily chosen for clarity of this example, and any query and response format may be used as desired, including binary encoded data. In this example, programmable device 120 updates the aggregated data to show that there are 234 instances of version 3.25, 199 instances of version 3.00; and 5 instances of version 1.00. Such a variety of versions of software is common in large enterprises. After aggregating its local data into the query responses, programmable device 120 passes or forwards the aggregated data to programmable device 130.

Programmable device 130 has been compromised by malware. Instead of aggregating the data received from programmable device 120 with the local responses to the query, programmable device 120 corrupts the data, decreasing the value for version 3.25 from 234 to 9; for version 3.00 from 199 to 1; and increasing the value for version 1.00 to 898. Compromised programmable device 130 then passes the corrupted aggregated data on to programmable device 140, which cannot detect the corruption. Programmable device 140 increments the stored values with local data, indicating aggregate counts of 10 for version 3.25; 1 for version 3.00; and 898 for version 1.00. Programmable device 130 then passes the aggregated data to programmable device 150, which aggregates its own local data corresponding of the query before forward the aggregated data on to server 110 for analysis and possible actions.

The aggregated data in this example is a simple query response, but any data may be used, in any desired format. Typically, the aggregated data is protected to avoid accidental or intentional corruption of the aggregated data. Any technique for protecting the data may be used, including encryption, digital signatures, etc. In one embodiment, the data payload is not protected. The following description is written in terms of an implementation that uses a digital signature for sealing the data payload.

In one embodiment, each of the programmable devices 120-150 receives the data from its predecessor, authenticates the digital signature contained in the data, updates the data, then resigns the aggregated data using a digital signature. The nature of the signature is outside of the scope of the current disclosure, and any type of digital signature may be used that allows authenticating the digitally signed aggregated data. Where the data is encrypted, the programmable device decrypts the data, aggregates the local data, and encrypts the aggregated data for further transmission.

Because of the undetectable corruption of programmable device 130, the aggregated data is made meaningless, even though later or successor programmable devices correctly aggregate the aggregated data with their correct local data. Even if server 110 were able to detect by contents analysis that the aggregated data is likely corrupted, the server 110 would have no way to determine which of the programmable devices in the chain illustrated in FIG. 1 corrupted the data.

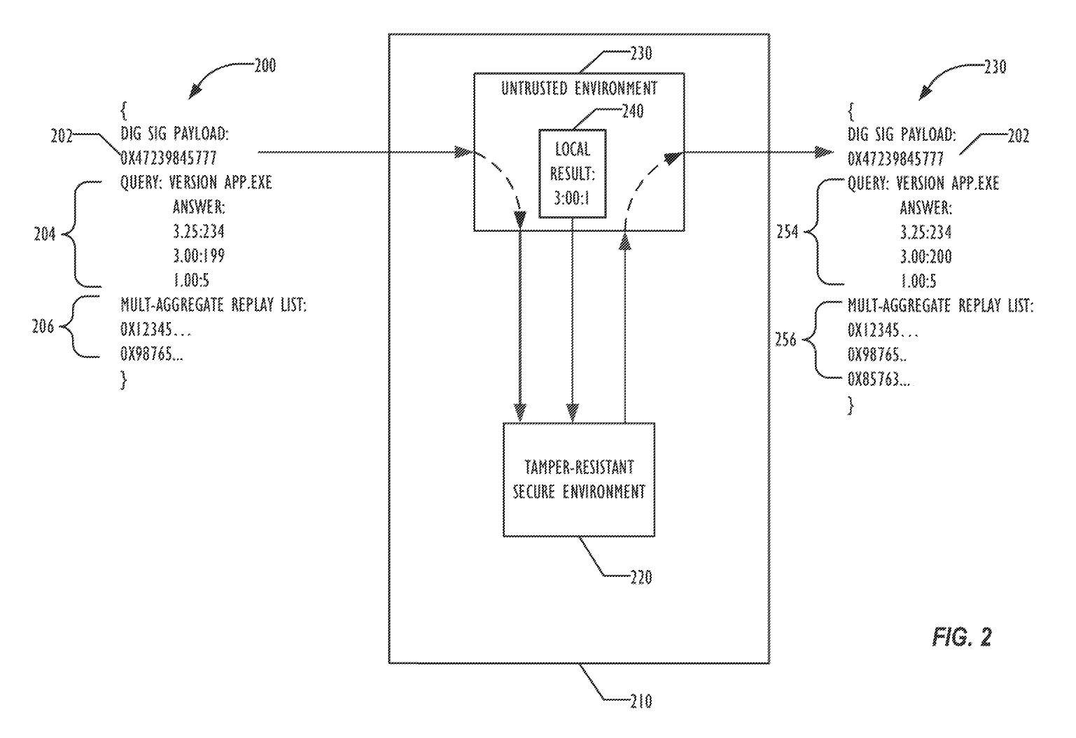

By moving the aggregation of the data from an untrusted environment to a trusted environment, the aggregate data may be made more tamper resistant. FIG. 2 illustrates an embodiment in which the trusted environment of a device receives the aggregate data from a predecessor device and locally generated data to be aggregated with the received aggregate data. The trusted environment aggregates the data and passes the aggregated data for delivery to a successor device.

In this example, an aggregated data payload 200 is received from a predecessor device by device 210. In one embodiment there are three portions of aggregated data payload 200 relevant to the current disclosure: a digital signature 202, a query and result portion 204, and an optional multi-aggregate replay list 206, each of which is described below. In another embodiment, the predecessor aggregated data is encrypted, with no digital signature, and the payload is decrypted, aggregated, then encrypted again. Embodiments may both digitally sign and encrypt the aggregated data. In the following, unsealing the predecessor aggregated data is defined as either authenticating the digital signature, decrypting the encrypted data, or both; similarly, resealing the successor aggregated data is defined as either digitally signing the data, encrypting the data, or both.

The device 210 includes both a trusted environment 220 and an untrusted environment 230. Typically, the untrusted environment is an operating system environment running untrusted application software, and the trusted environment is a secure environment only allowed to execute pre-approved functionality. The untrusted environment may include the operating system and a local agent software capable of producing local data relevant to the query of the aggregated data payload 200.

The untrusted environment 230 of the device 210 receives the signed aggregate data payload 200 from a predecessor programmable device and passes the payload to the trusted environment 220. In one embodiment, the untrusted environment 230 is able to unseal at least a portion of the aggregated payload 200 to determine the local data 240 that should be added to the aggregated data. In other embodiments, the untrusted environment 230 cannot unseal the aggregated data payload 200, but can recognize the payload 200 and pass it to the trusted environment 220. In such an embodiment, the trusted environment 220 may request the local agent in the untrusted environment 230 to generate the local data and provide the local data to the trusted environment 220.

Once the trusted environment 220 has the aggregated data payload 200 and the local data 240 to be aggregated with the payload 200, the trusted environment 220 unseals the aggregated data payload 200, aggregates the local data with the predecessor aggregated data to produce the output aggregated data payload 250, then reseals the output aggregated data payload 250 and passes it to the untrusted environment 230 for delivery to a successor device, which may either be another device that adds local data to the aggregation or a collector such as the server 110 that can unseal the aggregated data payload and extract the aggregated data for its desired use.

In some embodiments, the trusted environment 220 may directly obtain the predecessor aggregated data payload 200 or directly transmit the output aggregated data payload 250 without the intervention of the untrusted environment 230. In some embodiments, the trusted environment 220 may be able to generate the local data 240 instead of obtaining the local data from the untrusted environment.

In embodiments employing a digital signature 202, the digital signature 202 is used for securing the contents of the aggregated data 200 from tampering. The digital signature authenticated by the trusted environment (described in detail below) using an encryption key. Where encryption of the entire aggregated data is employed, the entire aggregated data is encrypted and decrypted by the trusted environment using one or more encryption keys. In one embodiment, the trusted environment each device 210 has its own private key that can be used to re-seal the aggregated data and a group public key that can be used to unseal the predecessor aggregated data, as well as the output aggregated data payload 250 produced by the device 210. Thus, each device 210 uses the group public key to unseal the aggregated data from the predecessor device, performs the aggregation, then reseals the aggregated data with its private key for passing on to a successor device. Alternately, symmetric encryption techniques may be used that use a single key for both encryption and decryption.

A query and response portion 204 may contain sufficient information to allow the device 210 to determine what local data should be aggregated, as well as the resulting aggregated data. Although in the examples illustrated in the Figures, the aggregation may involve arithmetic adding of the local data with the predecessor aggregated data, any other type of aggregation may be used as desired. As explained above, the format of the aggregated data payloads 200 and 250 are illustrative and by way of example only, and any format, textual, binary, or any mixture thereof, may be used as desired.

To avoid an attempt to tamper with the aggregated data by using the device 210 multiple times, in some embodiments a record may be kept of every device 210 that processes the aggregated data. This record may be a list or other record of unique identifiers associated with each device 210 that has processed the aggregated data. Alternately, predefined bins or slots may be used that are associated with each device 210, such that each device 210 as it processes the data indicates the bin or slot associated with that device 210 as having been used. Any other technique for keeping track of which devices have aggregated data into the collection may be used. The structure or format of the record is not significant, and any desired technique for indicating that a device has previously processed the aggregated data may be used. Although less secure, an embodiment of the techniques described herein may be implemented without record-keeping to detect multiple aggregations by the same device if desired.

In the example of FIG. 2, the query is the same query outlined in FIG. 1, requesting a count of how many instances of versions of APP.EXE. The predecessor aggregated data in portion 204 indicates 234 instances of version 3.25, 199 instances of version 3.00, and 5 instances of version 1.00. Two predecessor devices are indicated in portion 206, each identified by a unique identifier of which only an initial portion is shown in FIG. 2 for clarity.

The output aggregated data payload 250 illustrates the aggregation of the single instance of version 3.00 of the local data 240, updating the 3.00 record to indicate 200 instances in portion 254. The output payload 250 also adds an additional unique identifier to the portion 256, indicating that this device 210 has aggregated the data. Further attempts to cause the device 210 to aggregate data to this payload can then be detected.

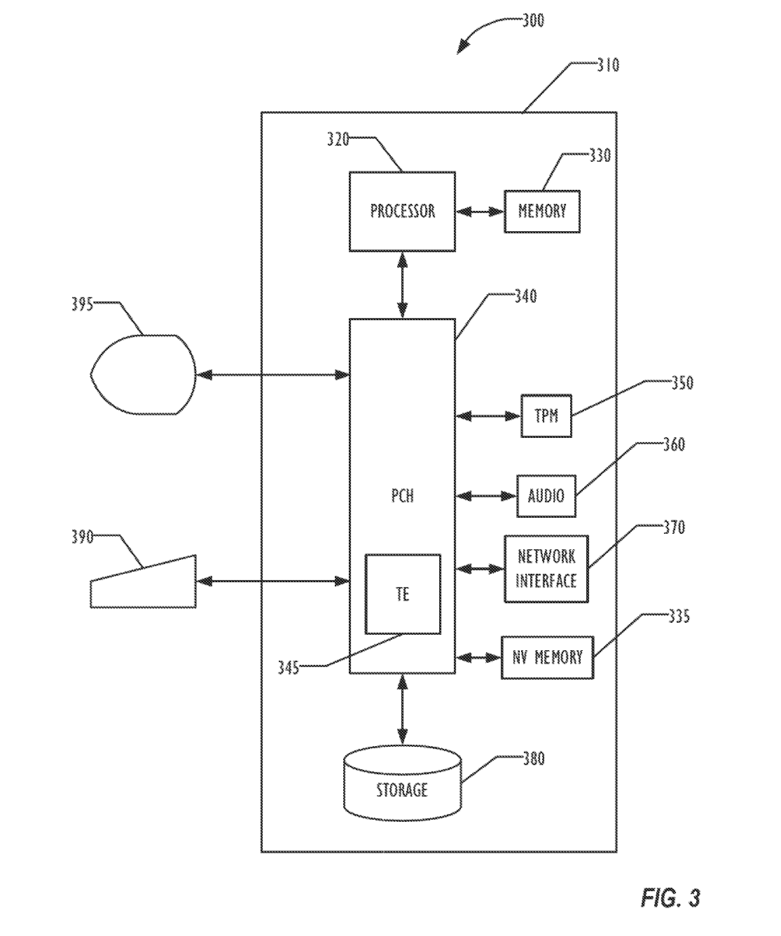

FIG. 3 is a block diagram illustrating a programmable device 300 that may be used to implement some or all of the techniques described herein. A system unit 310 provides a location where components of the programmable device 300 may be mounted or otherwise disposed. The system unit 310 may be manufactured as a motherboard on which various chipsets are mounted, providing electrical connection between the components and signal and power distribution throughout the system unit 310 and external to the system unit 310 as desired. For example, the programmable device 300 may include an output device such as display 395, which provides a way to display alerts or other indications that the anti-malware system has detected the possibility of malware by examining the aggregated data.

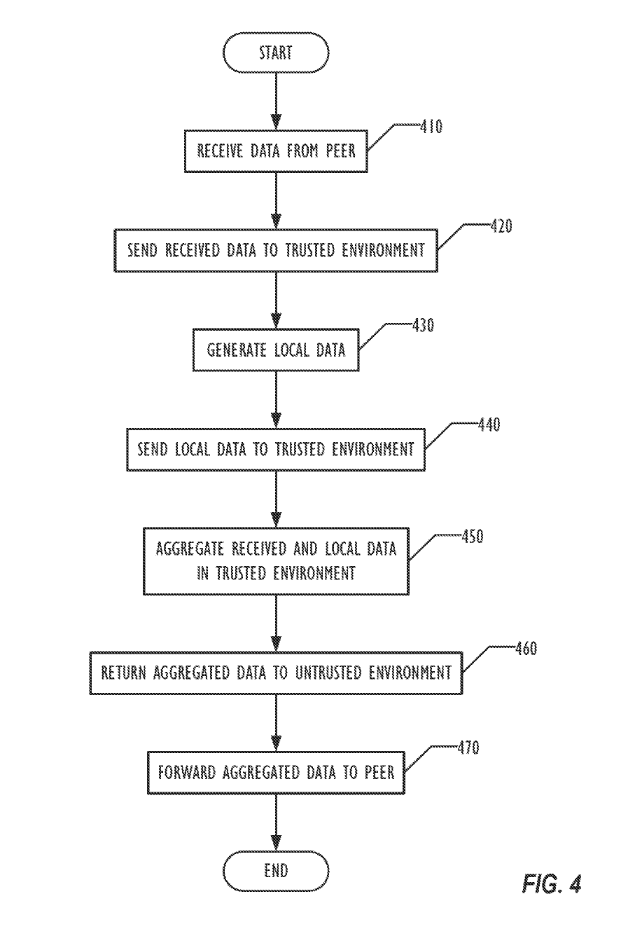

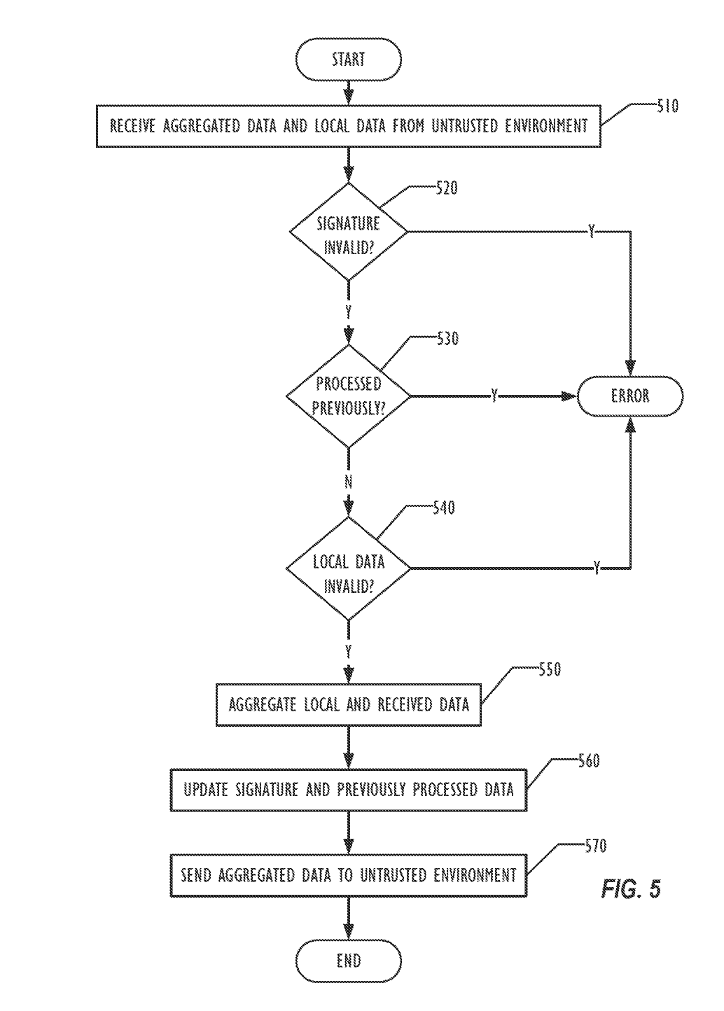

Various components of the system unit 310 may include one or more processor 320, typically each a single processor chip mounted in a mounting socket (not shown in FIG. 3) to provide electrical connectivity between the processors 320 and other components of the programmable device 300. Although a single processor 320 is illustrated in FIG. 3, any desired number of processors can be used, each of which may be a multi-core processor. Multiple processor chips are available on the market currently, and any desired processor chip or chipset may be used. The system unit 310 may be programmed to perform methods in accordance with this disclosure, examples of which are illustrated in FIGS. 4-5.

The processor 320 is connected to memory 330 for use by the processor 320, typically using a link for signal transport that may be a bus or any other type of interconnect, including point-to-point interconnects. Memory 330 may include one or more memory modules and comprise random access memory (RAM), read only memory (ROM), programmable read only memory (PROM), programmable read-write memory, and solid-state memory. The processor 320 may also include internal memory, such as cache memory. An operating system running on the processor 320 generally controls the operation of the programmable device 300, providing an operating system environment for services, applications, and other software to execute on the programmable device 300.

As illustrated in FIG. 3, processor 320 is also connected to a I/O subsystem 340 that provides I/O, timer, and other useful capabilities for the programmable device 300. For example, the I/O subsystem 340 may provide I/O ports for connecting an optional display 395 and an optional input device 390, such as a keyboard, mouse, touch screen, to the system unit 310. The ports may be either one or more of special-purpose ports for components like the display 395 or multipurpose ports such as Universal Serial Bus (USB) ports for connecting a keyboard or mouse 390. The I/O subsystem 340 may also an interface for communicating with storage devices such as storage device 380, connect to audio devices through an audio interface 360, and connect to the network 120 via network interface 370. The storage device 380 represents any form of non-volatile storage including, but not limited to, all forms of optical and magnetic, including solid-state storage elements, including removable media, and may be included within system unit 310 or be external to system unit 310. Storage device 380 may be a program storage device used for storage of software to control programmable device 300, data for use by the programmable device 300 (including network flow data), or both. Although only a single storage device 380 is illustrated in FIG. 3 for clarity, any number of storage devices 380 may be provided as desired, depending on interface availability in the PCT. The I/O subsystem 340 may be implemented as one or more chips within the system unit 310. In some embodiments, the memory 330 may be connected to the I/O subsystem 340 instead of to the processor 320.

In addition, some embodiments may connect the I/O subsystem 340 to a Trusted Platform Module 350 that provides a cryptoprocessor for storing cryptographic keys to protect information. Embodiments may implement the functionality of the I/O subsystem 340 as one or more separate chips in the system unit 310.

As illustrated in FIG. 3, the I/O subsystem 340 provides hardware resources for the secure trusted environment (TE) 345. The TE 345 provides a secure environment not controlled by the operating system that controls the programmable device 300. In other embodiments, the TE 345 may be outboard of the I/O subsystem as a separate chipset, or may be incorporated in the processor 320, such as a separate core restricted to TE functionality. The TE 345 contains secure processing functionality that allows performing the secure environment side of the techniques described herein in a trusted environment that cannot be interfered with by malware, even malware that may run as a bootkit or rootkit on processor 320. Typically, vendors providing the TE 345 use proprietary or cryptographic techniques to ensure control over what functionality may execute in the TE 345, preventing execution of any but carefully vetted trusted programs to run in the TE 345. Special interfaces may be provided to allow software running on the processor 320 to request the TE 345 to perform desired functionality, such as requesting the TE 345 to perform the data aggregation functionality for the processor 320. The TE 345 may either use its own internal memory or use a portion of the memory 330 for data and firmware storage. Alternatively, instructions in the form of firmware for execution in the TE 345 may be loaded from a non-volatile memory device 345, such as a flash memory, upon powering up of the programmable device 300, and then loaded into a portion of the memory 330 for execution by the TE 345. In some embodiments, the TE 345 may be disabled and enabled as desired. These instructions may cause the TE 345 to perform the data aggregation functionality and other functionality not described herein. The data aggregation firmware may be provided by the secure environment vendor or may be provided by an intrusion detection system vendor and stored as firmware by permission of the secure environment vendor, in conjunction with the provision of operating system environment intrusion detection software. An example of a trusted environment that may be used for these techniques is the Manageability Engine in certain chipsets provided by Intel Corp. Although described herein generally in terms of a hardware-based TE 345, secure environments can be implemented in hardware, firmware, or software, or any combination thereof, as desired.

The programmable device 300 may be any type of programmable device, such as, for example, a smart phone, smart tablet, personal digital assistant (PDA), mobile Internet device (MID), convertible tablet, notebook computer, desktop computer, server, or smart television. The display 395, if present, may be any time of device for presenting an interface to the user, such as, for example, a touch screen or a liquid crystal display. The elements illustrated in FIG. 3 are illustrative and by way of example only, and elements shown in FIG. 3 may be combined or divided into multiple elements as desired. Other elements, such as geopositioning logic such as a Global Positioning System transceiver, as well as logic for handling mobile communications using standards such as, for example, IEEE 802.11, IEEE 802.16, WiMax, etc., may also be provided as desired.

FIG. 4 is a flowchart illustrating the disclosed techniques according to one embodiment. In block 410, the device 210 receives aggregated data 200 from a predecessor. If the device 210 is the first device in the chain, an initialization of the aggregated data occurs either at the first device or by instruction from a control device such as the server 110. Alternately, the server 110 may send an initial aggregated data to a first device in the chain. The device 210 sends the aggregated data to the trusted environment 220 from the untrusted environment 230 in block 420. In embodiments where the trusted environment 220 receives the predecessor aggregated data 200 directly from the predecessor device, block 420 may be omitted.

The untrusted environment 230 generates the local data 240 to be aggregated with the predecessor aggregated data 200 in block 430. The techniques used to generate the local data 240 are dependent upon the data to be collected, and are not further described herein. The untrusted environment 230 sends the local data 240 to the trusted environment in block 440. In some embodiments, the trusted environment 220 may be capable of generating the local data 240 instead of receiving the local data 240 from the untrusted environment 230. Alternately, the trusted environment 230 may determine what local data 240 is required and request the untrusted environment 220 to generate the local data 240 and provide the local data 240 to the trusted environment 220.

In block 450, the trusted environment 220 unseals the predecessor aggregated data payload 200 and aggregates the local data 240 with the predecessor aggregated data 204, producing the aggregated data 254. The trusted environment 220 then seals the aggregated data 254 into the aggregated data payload 250. In an embodiment in which the aggregated data payload includes a record 206 of previous devices that of aggregated data, the trusted environment 220 updates the aggregated data 250 to include a record indicating that the device 210 processed the aggregated data 250. As described above, that record may be a unique identifier associated with the device 210, or any other information to indicate that the device 210 processed the aggregated data 250.

The trusted environment 220 in block 460 returns the output aggregated data 250 to the untrusted environment 230 for transmittal to a successor device in block 470. In an embodiment in which the trusted environment 220 can directly receive or send the aggregated data, block 460 may be omitted. The resulting aggregated data is more tamper-resistant, because unless the trusted environment 220 is itself corrupted, the untrusted environment 230 is unable to modify or corrupt the aggregated data.

FIG. 5 is a flowchart illustrating an embodiment of a technique used by the trusted environment 220 to aggregate data. In block 510, the trusted environment receives the predecessor aggregated data 200 and the local data 240 from the untrusted environment 230.

In block 520, the trusted environment 220 determines whether the signature 202 in the predecessor aggregated data payload 200 is valid. In an embodiment without a digital signature, block 520 may involve decryption of the encrypted aggregated data payload 200. If the digital signature is not authenticated or the decryption of the encrypted aggregated data payload 200 fails, the trusted environment 220 may signal an error condition and take any desired error action, including throwing away the predecessor aggregated data 200 or signaling the server 110, the untrusted environment 230, or any other receiver of alerts that may be desired. In block 530, the trusted environment 220 may evaluate the record of prior aggregators of the aggregated data 200, and if the device 210 has previously processed the predecessor aggregated data 200, the trusted environment 220 may indicate an error condition and take any desired area action, including throwing away the predecessor aggregated data 200 or signaling the server 110, the untrusted environment 230, or any other receiver of alerts that may be desired.

In an embodiment where flooding techniques may be used to pass aggregated data to multiple successor devices, the check to see whether the data has been processed previously by the current device 210 may be used to avoid inadvertent reprocessing of the data by the same device 210. In such an embodiment, the trusted environment 220 may simply throw away aggregated data payloads that the trusted environment 220 has previously processed, without any error indication or alert. In other embodiments, where reprocessing may indicate that a malicious attempt is being made to tamper with the aggregated data, the detection in block 530 may result in an alert that malicious activity has been discovered.

If the device 210 has not previously processed the predecessor aggregate data 200, the trusted environment 220 checks to see if the local data provided by the untrusted environment 230 is valid in block 540. In one embodiment, the trusted environment 220 may perform checks on the local data provided by the untrusted environment 230, to detect an attempt by the untrusted environment 230 to provide corrupted local data for aggregation. In other embodiments, the trusted environment 220 only checks the local data as to form. If the local data is not valid, the trusted environment 220 can then signal an error.

In one embodiment, should the trusted environment 220 determine that one or more of the error conditions of blocks 520-540 are met, instead of throwing away the predecessor aggregated data or generating an alert, the trusted environment 220 may generate the output aggregated data 250 by simply outputting the predecessor aggregated data 200 unchanged as the output aggregated data 250.

Having now determined that the aggregated data and the local data are valid, the trusted environment 220 updates the predecessor aggregated data 200 with the local data in block 550. The aggregated data payload is then sealed, such as by encryption or by digitally signing the aggregated data payload in the trusted environment 220, and in embodiments that record the history of aggregation actions, the trusted environment 220 can also update the previously processed data area 256 to indicate that the trusted environment 220 processed the aggregated data.

In block 570, the aggregated data 250 can be sent to the untrusted environment 230 for delivery to the successor device. Alternately, where the trusted environment 220 is capable of sending and receiving the aggregated data directly, the trusted environment 220 may send the aggregated data 250 to a successor device without traversing the untrusted environment 230.

The error handling indicated as a result of blocks 520, 530, or 540 may take the form of an alert generated by the trusted environment 220 that is passed to the untrusted environment 230 for processing.

The order of actions illustrated in FIGS. 4-5 are illustrative and by way of example only, and other steps and ordering of steps may be performed as desired. For example, the trusted environment 220 may update the several portions of the aggregated data payload in any order as desired.

The following examples pertain to further embodiments.

Example 1 is a non-transitory computer-readable medium, on which are stored instructions comprising instructions that, when executed, cause a programmable device to: receive a first collection of data from a predecessor programmable device; generate a second collection of data, corresponding to the first collection of data; aggregate the first collection of data with the second collection of data in a trusted environment of the programmable device, producing a third collection of data; and send the third collection of data to a successor programmable device.

Example 2 includes the subject matter of example 1, wherein the first collection of data comprises a digital signature, and wherein the instructions further comprise instructions that, when executed, cause the programmable device to: authenticate the digital signature in the trusted environment; and digitally sign the third collection of data in the trusted environment.

Example 3 includes the subject matter of example 1, wherein the first collection of data is encrypted, and wherein the instructions further comprise instructions that, when executed, cause the programmable device to: decrypt the first collection of data in the trusted environment; and encrypt the third collection of data in the trusted environment.

Example 4 includes the subject matter of example 1, wherein the instructions to receive the first collection of data comprise instructions that, when executed, cause the programmable device to: receive the first collection of data by an untrusted environment of the programmable device; and forward the first collection of data from the untrusted environment to the trusted environment.

Example 5 includes the subject matter of example 1, wherein the instructions to send the third collection of data comprise instructions that, when executed, cause the programmable device to: send the third collection of data from the trusted environment to an untrusted environment of the programmable device; and send the third collection of data from the untrusted environment to the successor programmable device.

Example 6 includes the subject matter of example 1, wherein the instructions further comprise instructions that, when executed, cause the programmable device to: determine whether the trusted environment has processed the first collection of data previously.

Example 7 includes the subject matter of example 1, wherein the instructions further comprise instructions that, when executed, cause the programmable device to: omit the aggregation of the second collection of data with the first collection of data if an error condition is detected.

Example 8 includes the subject matter of example 1, wherein the instructions further comprise instructions that, when executed, cause the programmable device to: discard the first collection of data if an error condition is detected.

Example 9 includes the subject matter of example 1, wherein the instructions further comprise instructions that, when executed, cause the programmable device to: initialize the first collection of data.

Example 10 includes the subject matter of any of examples 1-3, wherein the instructions further comprise instructions that, when executed, cause the programmable device to: determine whether the trusted environment has processed the first collection of data previously.

Example 11 includes the subject matter of any of examples 1-3, wherein the instructions further comprise instructions that, when executed, cause the programmable device to: omit the aggregation of the second collection of data with the first collection of data if an error condition is detected.

Example 12 includes the subject matter of any of examples 1-3, wherein the instructions further comprise instructions that, when executed, cause the programmable device to: discard the first collection of data if an error condition is detected.

Example 13 includes the subject matter of any of examples 1-3, wherein the instructions further comprise instructions that, when executed, cause the programmable device to: initialize the first collection of data.

Example 14 includes the subject matter of any preceding example, wherein the first collection of data comprises a digital signature, and wherein the instructions further comprise instructions that, when executed, cause the programmable device to: unseal the first collection of data by authenticating a digital signature in the first collection of in the trusted environment or decrypting the first collection of data in the trusted environment; and seal the third collection of data by digitally signing the third collection of data in the trusted environment or encrypting the third collection of data in the trusted environment.

Example 15 includes the subject matter of any preceding example, wherein the instructions to receive the first collection of data comprise instructions that, when executed, cause the programmable device to: receive the first collection of data by an untrusted environment of the programmable device, forward the first collection of data from the untrusted environment to the trusted environment; send the third collection of data from the trusted environment to an untrusted environment of the programmable device; and send the third collection of data from the untrusted environment to the successor programmable device.

Example 16 includes the subject matter of any preceding example, wherein the instructions further comprise instructions that, when executed, cause the programmable device to: determine whether the trusted environment has processed the first collection of data previously.

Example 17 includes the subject matter of any preceding example, wherein the instructions further comprise instructions that, when executed, cause the programmable device to: omit the aggregation of the second collection of data with the first collection of data or discard the first collection of data if an error condition is detected.

Example 18. is a programmable device, comprising: a processor; an operating system, comprising instructions that, when executed by the processor, controls the processor and provides an untrusted environment for software to execute on the processor; a secure hardware trusted environment separate from the untrusted environment; a memory, in which is stored instructions that when executed by secure hardware trusted environment cause the secure hardware trusted environment to: receive a first collection of data from a predecessor programmable device; generate a second collection of data, corresponding to the first collection of data; aggregate the first collection of data with the second collection of data, producing a third collection of data; and send the third collection of data to a successor.

Example 19 includes the subject matter of example 18, where the memory further stores instructions that when executed in the untrusted environment cause the processor to: receive the first collection of data from the predecessor programmable device; forward the first collection of data from the untrusted environment to the trusted environment; receive the third collection of data from the trusted environment; and forward the third collection of data to the successor.

Example 20 includes the subject matter of example 18, wherein the instructions further comprise instructions that, when executed by the secure hardware trusted environment, cause the secure hardware trusted environment to: unseal the first collection of data; and seal the third collection of data.

Example 21 includes the subject matter of example 18, wherein the instructions further comprise instructions that, when executed by the secure hardware trusted environment, cause the secure hardware trusted environment to: determine whether the secure hardware trusted environment has previously processed the first collection of data.

Example 22 includes the subject matter of example 21, wherein the instructions further comprise instructions that, when executed by the secure hardware trusted environment, cause the secure hardware trusted environment to: signal an alert if the secure hardware trusted environment has previously processed the first collection of data.

Example 23 includes the subject matter of example 18, wherein the instructions further comprise instructions that, when executed by the secure hardware trusted environment, cause the secure hardware trusted environment to: discard the first collection of data if an error condition is detected.

Example 24 includes the subject matter of example 18, wherein the instructions further comprise instructions that, when executed by the secure hardware trusted environment, cause the secure hardware trusted environment to: initialize the first collection of data in the absence of a predecessor programmable device.

Example 25 includes the subject matter of any of examples 18-19, wherein the instructions further comprise instructions that, when executed by the secure hardware trusted environment, cause the secure hardware trusted environment to: unseal the first collection of data; and seal the third collection of data.

Example 26 includes the subject matter of any of examples 18-19 and 25, wherein the instructions further comprise instructions that, when executed by the secure hardware trusted environment, cause the secure hardware trusted environment to: determine whether the secure hardware trusted environment has previously processed the first collection of data.

Example 27 includes the subject matter of example 26, wherein the instructions further comprise instructions that, when executed by the secure hardware trusted environment, cause the secure hardware trusted environment to: signal an alert if the secure hardware trusted environment has previously processed the first collection of data.

Example 28 includes the subject matter of example 18, where the memory further stores instructions that when executed in the untrusted environment cause the processor to: receive the first collection of data from the predecessor programmable device; and forward the first collection of data from the untrusted environment to the trusted environment.

Example 29 includes the subject matter of example 28, where the memory further stores instructions that when executed in the untrusted environment cause the processor to: receive the third collection of data from the trusted environment; and forward the third collection of data to the successor.

Example 30 includes the subject matter of example 20, wherein the instructions that when executed cause the secure hardware trusted environment to unseal the first collection of data comprise instructions that when executed cause the secure hardware trusted environment to authenticate a digital signature contained in the first collection of data, and wherein the instructions that when executed cause the secure hardware trusted environment to seal the third collection of data comprise instructions that when executed cause the secure hardware trusted environment to digitally sign the third collection of data.

Example 31 includes the subject matter of example 20, wherein the instructions that when executed cause the secure hardware trusted environment to unseal the first collection of data comprise instructions that when executed cause the secure hardware trusted environment to decrypt the first collection of data, and wherein the instructions that when executed cause the secure hardware trusted environment to seal the third collection of data comprise instructions that when executed cause the secure hardware trusted environment to encrypt the third collection of data.

Example 32 includes the subject matter of any of examples 18-20 and 28-31, wherein the instructions further comprise instructions that, when executed by the secure hardware trusted environment, cause the secure hardware trusted environment to: determine whether the secure hardware trusted environment has previously processed the first collection of data.

Example 33 includes the subject matter of example 32, wherein the instructions further comprise instructions that, when executed by the secure hardware trusted environment, cause the secure hardware trusted environment to: signal an alert if the secure hardware trusted environment has previously processed the first collection of data.

Example 34 includes the subject matter of any of examples 18-20 and 28-31, wherein the instructions further comprise instructions that, when executed by the secure hardware trusted environment, cause the secure hardware trusted environment to: discard the first collection of data if an error condition is detected.

Example 35 includes the subject matter of any of examples 18-20 and 28-31, wherein the instructions further comprise instructions that, when executed by the secure hardware trusted environment, cause the secure hardware trusted environment to: omit the aggregation of the second collection of data with the first collection of data if an error condition is detected.

Example 36 includes the subject matter of any of examples 18-20 and 28-31, wherein the instructions further comprise instructions that, when executed, cause the programmable device to: initialize the first collection of data.

Example 37. is a method, comprising: receiving a first collection of data from a first programmable device; obtaining a second collection of data from an untrusted environment of a second programmable device; combining the first collection of data with the second collection of data in a trusted environment of the programmable device to produce a third collection of data; and sending the third collection of data to a third programmable device.

Example 38 includes the subject matter of example 37, wherein combining the first collection of data with the second collection of data comprises: unsealing the first collection of data; combining the first collection of data with the second collection of data to produce the third collection of data; and sealing the third collection of data.

Example 39 includes the subject matter of example 38, wherein unsealing the first collection of data comprises authenticating a digital signature of the first collection of data, and wherein sealing the third collection of data comprises digitally signing the third collection of data.

Example 40 includes the subject matter of example 37, wherein obtaining the second collection of data from an untrusted environment comprises: evaluating in the untrusted environment a query contained in the first collection of data; and forwarding a query result to the trusted environment.

Example 41 includes the subject matter of example 37, wherein obtaining the second collection of data from an untrusted environment comprises: evaluating in the trusted environment a query contained in the first collection of data; and requesting data corresponding to the query from the untrusted environment by the trusted environment.

Example 42 includes the subject matter of example 37, wherein receiving a first collection of data comprises: receiving the first collection of data from the first programmable device in the untrusted environment of the second programmable device; and forwarding the first collection of data from the untrusted environment to the trusted environment, and wherein sending the third collection of data to a third programmable device comprises: sending the third collection of data from the trusted environment to the untrusted environment; and forwarding the third collection of data from the untrusted environment to the third programmable device.

Example 43 includes the subject matter of example 37, wherein combining the first collection of data with the second collection of data comprises: determining whether the second programmable device has previously processed the first collection of data.

Example 44 includes the subject matter of example 37, wherein combining the first collection of data with the second collection of data further comprises: discarding the first collection of data if an error condition is detected in the first collection of data.

Example 45 includes the subject matter of example 37, wherein combining the first collection of data with the second collection of data further comprises: generating an alert if an error condition is detected in the first collection of data.

Example 46 includes the subject matter of any of examples 37-41, wherein receiving a first collection of data comprises: receiving the first collection of data from the first programmable device in the untrusted environment of the second programmable device; and forwarding the first collection of data from the untrusted environment to the trusted environment, and wherein sending the third collection of data to a third programmable device comprises: sending the third collection of data from the trusted environment to the untrusted environment; and forwarding the third collection of data from the untrusted environment to the third programmable device.

Example 47 includes the subject matter of any of examples 37-41, wherein combining the first collection of data with the second collection of data comprises: determining whether the second programmable device has previously processed the first collection of data.

Example 48 includes the subject matter of any of examples 37-41, wherein combining the first collection of data with the second collection of data further comprises: discarding the first collection of data if an error condition is detected in the first collection of data.

Example 49 includes the subject matter of any of examples 37-41, wherein combining the first collection of data with the second collection of data further comprises: generating an alert if an error condition is detected in the first collection of data.

Example 50. is an apparatus comprising means to perform a method as claimed in any of claims 37-41.

Example 51 includes the subject matter of example 37, wherein combining the first collection of data with the second collection of data comprises: unsealing the first collection of data, comprising one or more of authenticating a digital signature in the first collection of data or decrypting the first collection of data; combining the first collection of data with the second collection of data to produce the third collection of data; and sealing the third collection of data, comprising one or more of digitally signing the third collection of data or encrypting the third collection of data.

Example 52 includes the subject matter of any of examples 37 and 51, wherein obtaining the second collection of data from an untrusted environment comprises: evaluating a query contained in the first collection of data; and providing a query result to the trusted environment.

Example 53 includes the subject matter of any of examples 37-38 and 51, wherein receiving a first collection of data comprises: receiving the first collection of data from the first programmable device in the untrusted environment of the second programmable device; and forwarding the first collection of data from the untrusted environment to the trusted environment, and wherein sending the third collection of data to a third programmable device comprises: sending the third collection of data from the trusted environment to the untrusted environment; and forwarding the third collection of data from the untrusted environment to the third programmable device.

Example 54 includes the subject matter of any of examples 37-38 and 51, wherein combining the first collection of data with the second collection of data comprises: determining whether the second programmable device has previously processed the first collection of data.

Example 55 includes the subject matter of example 38, wherein unsealing the first collection of data comprises decrypting the first collection of data, and wherein sealing the third collection of data comprises encrypting the third collection of data.

Example 56 includes the subject matter of any of examples 37-41, wherein receiving a first collection of data comprises: receiving the first collection of data from the first programmable device in the untrusted environment of the second programmable device; and forwarding the first collection of data from the untrusted environment to the trusted environment.

Example 57 includes the subject matter of any of examples 37-41, wherein sending the third collection of data to a third programmable device comprises: sending the third collection of data from the trusted environment to the untrusted environment; and forwarding the third collection of data from the untrusted environment to the third programmable device.

Example 58 includes the subject matter of any of examples 37-41, wherein combining the first collection of data with the second collection of data comprises: determining whether the second programmable device has previously processed the first collection of data.

Example 59 includes the subject matter of any of examples 37-41, wherein combining the first collection of data with the second collection of data further comprises: discarding the first collection of data if an error condition is detected in the first collection of data.

Example 60 includes the subject matter of any of examples 37-41, wherein combining the first collection of data with the second collection of data further comprises: generating an alert if an error condition is detected in the first collection of data.

Example 61 includes the subject matter of any of examples 37-41, wherein combining the first collection of data with the second collection of data further comprises: omitting combining the local data with the first collection of data if an error condition is detected in the first collection of data.

Example 62 includes the subject matter of any of examples 37-41, wherein combining the first collection of data with the second collection of data further comprises: initializing the first collection of data in the absence of the first programmable device.

Example 63. is a machine readable medium on which are stored instructions that when executed by a programmable device cause the programmable device to perform the method of any one of claims 37-62.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled.

1-25. (canceled)

26. A computer-readable medium, on which are stored instructions comprising instructions that, when executed, cause a programmable device to:
receive a first collection of data from a predecessor programmable device;
generate a second collection of data, corresponding to the first collection of data;
aggregate the first collection of data with the second collection of data in a trusted environment of the programmable device, producing a third collection of data; and
send the third collection of data to a successor programmable device.

27. The computer-readable medium of claim 26, wherein the first collection of data comprises a digital signature, and
wherein the instructions further comprise instructions that, when executed, cause the programmable device to:
authenticate the digital signature in the trusted environment; and
digitally sign the third collection of data in the trusted environment.

28. The computer-readable medium of claim 26, wherein the first collection of data is encrypted, and
wherein the instructions further comprise instructions that, when executed, cause the programmable device to:
decrypt the first collection of data in the trusted environment; and
encrypt the third collection of data in the trusted environment.

29. The computer-readable medium of claim 26, wherein the instructions to receive the first collection of data comprise instructions that, when executed, cause the programmable device to:
receive the first collection of data by an untrusted environment of the programmable device; and
forward the first collection of data from the untrusted environment to the trusted environment.

30. The computer-readable medium of claim 26, wherein the instructions to send the third collection of data comprise instructions that, when executed, cause the programmable device to:
send the third collection of data from the trusted environment to an untrusted environment of the programmable device; and
send the third collection of data from the untrusted environment to the successor programmable device.

31. The computer-readable medium of claim 26, wherein the instructions further comprise instructions that, when executed, cause the programmable device to:
determine whether the trusted environment has processed the first collection of data previously.

32. The computer-readable medium of claim 26, wherein the instructions further comprise instructions that, when executed, cause the programmable device to:
omit the aggregation of the second collection of data with the first collection of data if an error condition is detected.

33. The computer-readable medium of claim 26, wherein the instructions further comprise instructions that, when executed, cause the programmable device to:
discard the first collection of data if an error condition is detected.

34. The computer-readable medium of claim 26, wherein the instructions further comprise instructions that, when executed, cause the programmable device to:
initialize the first collection of data.

35. A programmable device, comprising:
a processor,
an operating system, comprising instructions that, when executed by the processor, controls the processor and provides an untrusted environment for software to execute on the processor;
a secure hardware trusted environment separate from the untrusted environment;
a memory, in which is stored instructions that when executed by secure hardware trusted environment cause the secure hardware trusted environment to:
receive a first collection of data from a predecessor programmable device;
generate a second collection of data, corresponding to the first collection of data;
aggregate the first collection of data with the second collection of data in, producing a third collection of data; and
send the third collection of data to a successor.

36. The programmable device of claim 35, where the memory further stores instructions that when executed in the untrusted environment cause the processor to:
receive the first collection of data from the predecessor programmable device;
forward the first collection of data from the untrusted environment to the trusted environment;
receive the third collection of data from the trusted environment; and
forward the third collection of data to the successor.

37. The programmable device of claim 35, wherein the instructions further comprise instructions that, when executed by the secure hardware trusted environment, cause the secure hardware trusted environment to:
unseal the first collection of data; and
seal the third collection of data.

38. The programmable device of claim 35, wherein the instructions further comprise instructions that, when executed by the secure hardware trusted environment, cause the secure hardware trusted environment to:
determine whether the secure hardware trusted environment has previously processed the first collection of data.

39. The programmable device of claim 38, wherein the instructions further comprise instructions that, when executed by the secure hardware trusted environment, cause the secure hardware trusted environment to:
signal an alert if the secure hardware trusted environment has previously processed the first collection of data.

40. The programmable device of claim 35, wherein the instructions further comprise instructions that, when executed by the secure hardware trusted environment, cause the secure hardware trusted environment to:
discard the first collection of data if an error condition is detected.

41. The programmable device of claim 35, wherein the instructions further comprise instructions that, when executed by the secure hardware trusted environment, cause the secure hardware trusted environment to:
initialize the first collection of data in the absence of a predecessor programmable device.

42. A method, comprising:
receiving a first collection of data from a first programmable device;
obtaining a second collection of data from an untrusted environment of a second programmable device;
combining the first collection of data with the second collection of data in a trusted environment of the programmable device to produce a third collection of data; and
sending the third collection of data to a third programmable device.

43. The method of claim 42, wherein combining the first collection of data with the second collection of data comprises:
unsealing the first collection of data;
combining the first collection of data with the second collection of data to produce the third collection of data; and
sealing the third collection of data.

44. The method of claim 43,
wherein unsealing the first collection of data comprises authenticating a digital signature of the first collection of data, and
wherein sealing the third collection of data comprises digitally signing the third collection of data.

45. The method of claim 42, wherein obtaining the second collection of data from an untrusted environment comprises:
evaluating in the untrusted environment a query contained in the first collection of data; and
forwarding a query result to the trusted environment.

46. The method of claim 42, wherein obtaining the second collection of data from an untrusted environment comprises:
evaluating in the trusted environment a query contained in the first collection of data; and
requesting data corresponding to the query from the untrusted environment by the trusted environment.

47. The method of claim 42,
wherein receiving a first collection of data comprises:
receiving the first collection of data from the first programmable device in the untrusted environment of the second programmable device; and
forwarding the first collection of data from the untrusted environment to the trusted environment, and
wherein sending the third collection of data to a third programmable device comprises:
sending the third collection of data from the trusted environment to the untrusted environment; and
forwarding the third collection of data from the untrusted environment to the third programmable device.

48. The method of claim 42, wherein combining the first collection of data with the second collection of data comprises:
determining whether the second programmable device has previously processed the first collection of data.

49. The method of claim 42, wherein combining the first collection of data with the second collection of data further comprises:
discarding the first collection of data if an error condition is detected in the first collection of data.

50. The method of claim 42, wherein combining the first collection of data with the second collection of data further comprises:
generating an alert if an error condition is detected in the first collection of data.
